(19) United States
(12) Patent Application Publication
(10) Pub. No.: US 2016/0156239 A1
(43) Pub. Date: Jun. 2, 2016

(54) POWER COLLECTION DEVICE FOR ELECTRIC MACHINE

(71) Applicant: INDUSTRIAL TECHNOLOGY RESEARCH INSTITUTE, Hsinchu Hsien (TW)

(72) Inventors: I-Wei LAN, Hsinchu (TW); Han-Ping YANG, Hsinchu (TW)

(73) Assignee: INDUSTRIAL TECHNOLOGY RESEARCH INSTITUTE, Hsinchu Hsien (TW)

(21) Appl. No.: 14/930,014

(22) Filed: Nov. 2, 2015

(30) Foreign Application Priority Data
Dec. 2, 2014 (TW) 103141749

(51) Int. Cl. H02K 3/28

(52) U.S. Cl. CPC H02K 3/28

(57) ABSTRACT

A power collection device for an electric machine is provided, which includes: a carrier having a first surface, and a connecting member protruding outward from the first surface of the carrier and having at least a first groove. The first groove facilitates to reduce stresses experienced by the connecting member and allows applied stresses to change the configuration of the connection portion so as to increase the contact area between the connecting member and an object held in the connecting member. As such, the object is firmly secured in the connecting member and the processing convenience is increased.

### CROSS REFERENCE TO RELATED APPLICATION

This application also claims priority to Taiwan Patent Application No. 103141749 filed in the Taiwan Patent Office on Dec. 2, 2014, the entire content of which is incorporated herein by reference.

### BACKGROUND

1. Technical Field

The present disclosure relates to power collection devices for electric machines, and more particularly, to a power collection device for improving the fixing effect.

2. Description of Related Art

FIG. 1A is a schematic view of a conventional mild hybrid propulsion system. Referring to FIG. 1A, an integrated starter-generator (ISG) 7 is disposed between an engine 4 and a transmission 5. To apply the mild hybrid propulsion system in a vehicle, the ISG is designed to have a minimized size so as to save space in the vehicle.

FIG. 1B is a schematic partial view of the ISG 7. Referring to FIGS. 1A and 1B, the ISG 7 has a stator 2 and a power collection device 9 disposed around the stator 2. Copper wires 201 of the stator 2 are collected by the power collection device 9 into phase cables 3 for electrically connecting with an external electronic element.

In particular, the stator 2 has a plurality of winding units 20, and the power collection device 9 has a plurality of rivets 91. The copper wires 201 of the winding units 20 are wound to the rivets 91 and bonded and fixed through a soldering process. Then, the copper wires 20 are collected by a guiding mechanism 92 into phase cables 3 for electrically connecting with an external electronic element.

However, the rivet bonding method complicates the fabrication process and increases the volume of the ISG. Further, the rivets easily come loose. As such, the fabrication cost is increased and the product reliability is reduced.

Therefore, how to overcome the above-described drawbacks has become critical.

### SUMMARY

In view of the above-described drawbacks, the present disclosure provides a power collection device for an electric machine, which comprises: a carrier of a ring shape having a first surface and a second surface; and at least a connecting member protruding outward from the first surface of the carrier, and having at least a first groove and a plane formed on two opposite sides of the connecting member, respectively.

The first groove facilitates to reduce stresses experienced by the connecting member and allows applied stresses to change the configuration of the connection portion wrapping copper wires so as to increase the contact area between the connecting member and the copper wires. As such, the copper wires are firmly secured in the connecting member and the processing convenience is increased.

### BRIEF DESCRIPTION OF DRAWINGS

FIG. 1A is a schematic view of a conventional mild hybrid propulsion system;

FIG. 1B is a schematic partial view of a conventional ISG (integrated starter-generator);

FIG. 2A is a schematic partial view of a power collection device for an electric machine according to a first embodiment of the present disclosure;

FIG. 2B is a schematic partial view of a power collection device for an electric machine according to a second embodiment of the present disclosure;

FIGS. 2C and 2D are schematic views of a connecting member of the present disclosure;

FIG. 3 is a schematic view showing folding of the connecting member of the present disclosure;

FIG. 4 is a schematic partial view of an ISG of the present disclosure;

FIGS. 5A and 5B are schematic views showing folding of the connecting member of the present disclosure; and

FIG. 6 is a schematic view of a mild hybrid propulsion system of the present disclosure.

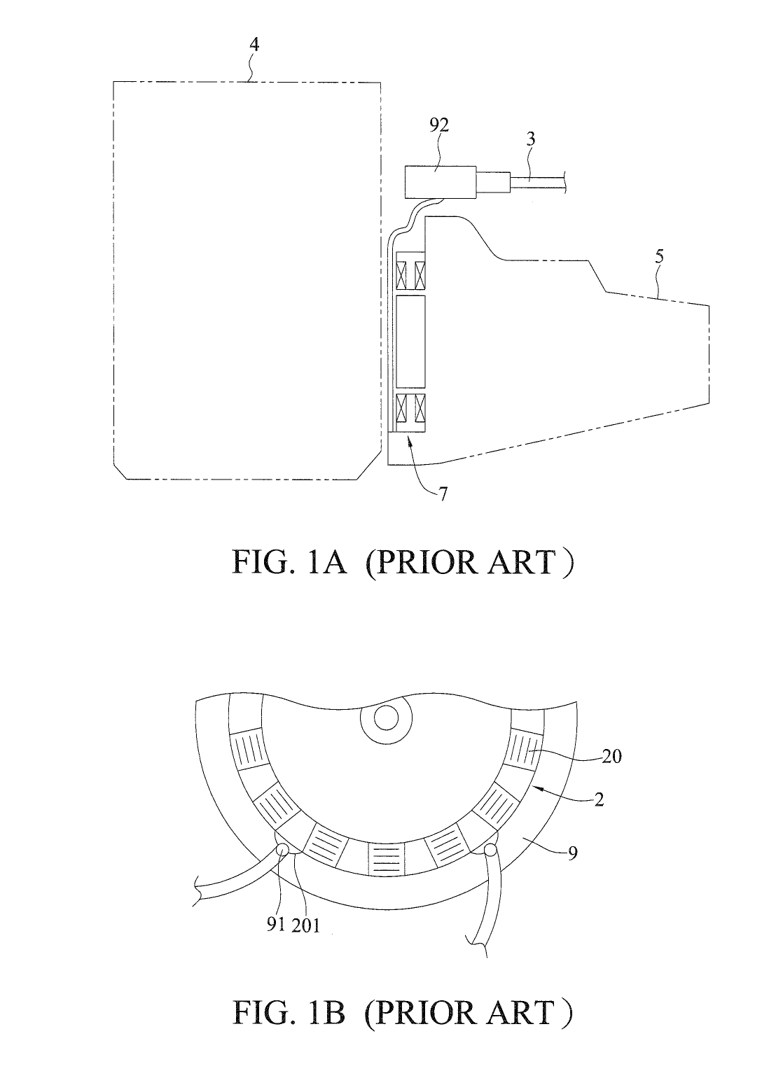

### DETAILED DESCRIPTION

The following illustrative embodiments are provided to illustrate the present disclosure, these and other advantages and effects can be apparent to those in the art after reading this specification. It should be noted that all the drawings are not intended to limit the present disclosure. Various modifications and variations can be made without departing from the spirit of the present disclosure.

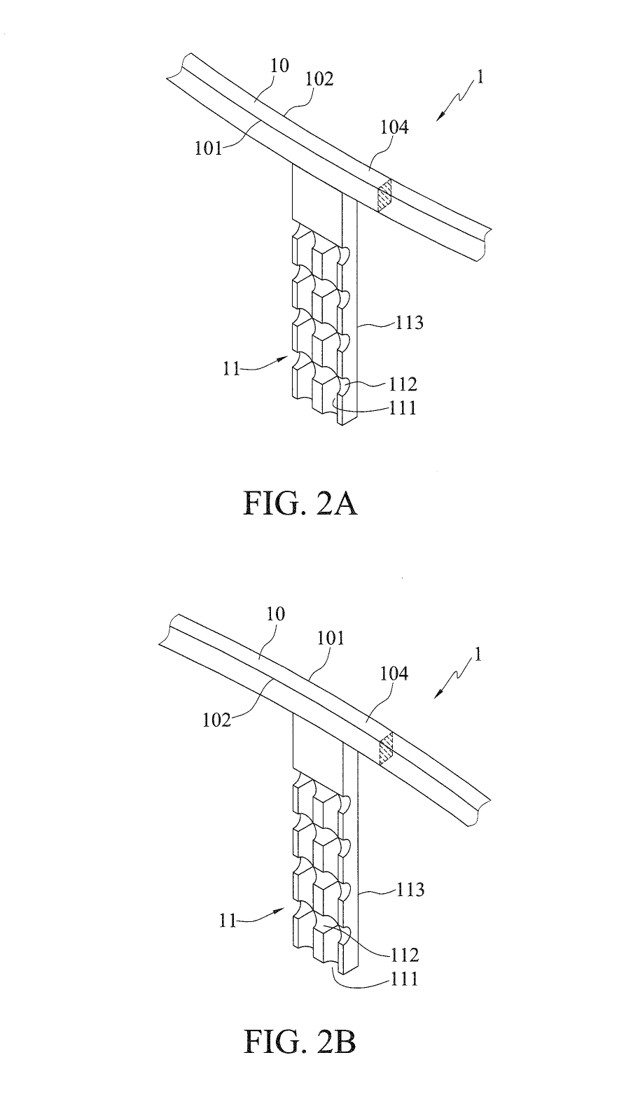

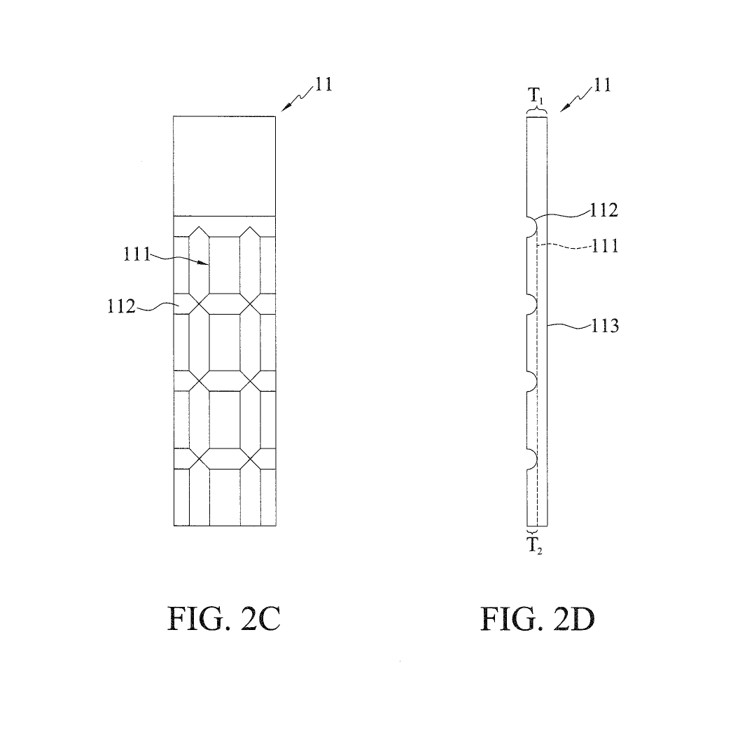

FIG. 2A is a schematic partial view of a power collection device 1 for an electric machine according to a first embodiment of the present disclosure, and FIG. 2B is a schematic partial view of the power collection device 1 for an electric machine according to a second embodiment of the present disclosure.

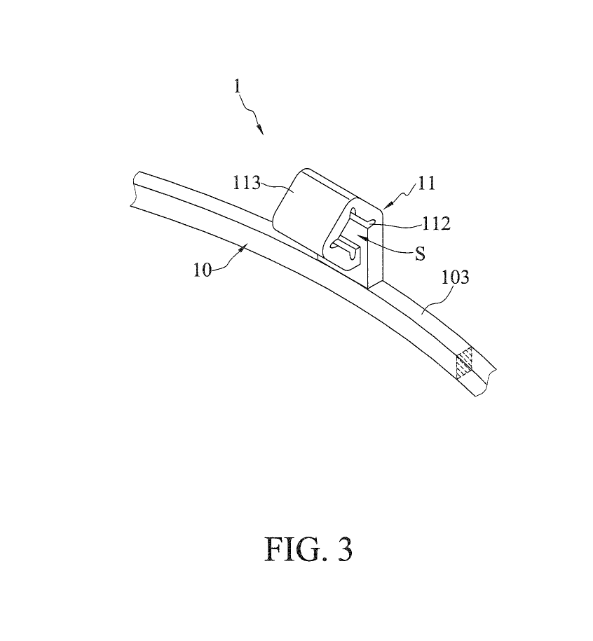

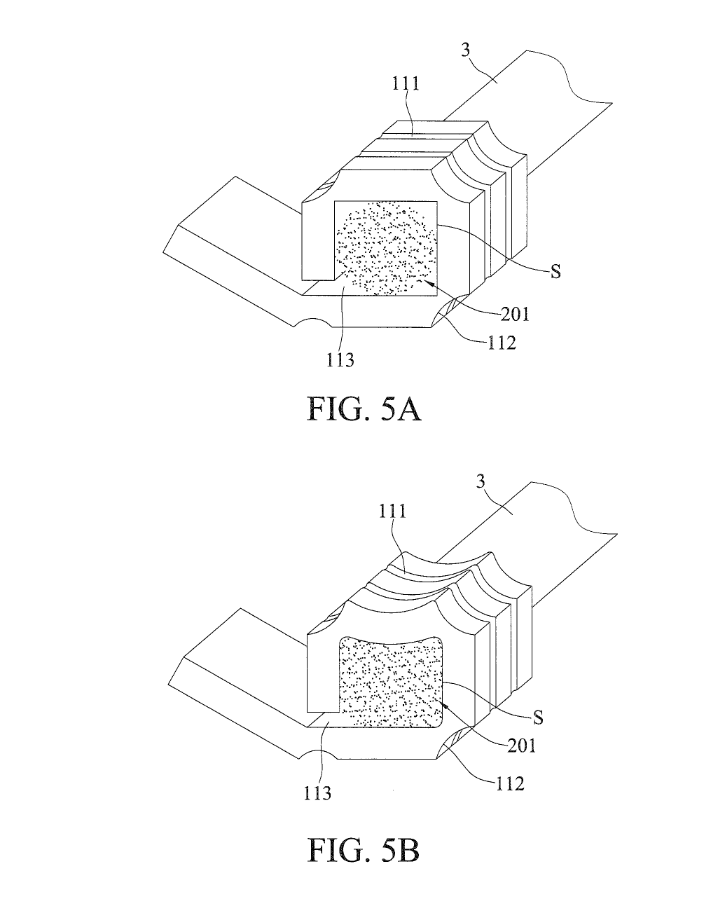

The power collection device 1 has a carrier 10 and a connecting member 11. The carrier 10 is of a ring shape, which has an outer diameter 101, an inner diameter 102, a first surface 103 and a second surface 104 (as shown in FIG. 3). The connecting member 11 protrudes outward from the first surface 103. The connecting member 11 is in a plate shape. At least two first grooves 111 are formed along a length extending direction of the connecting member 11. Based on an inscribed circle principle, at least three second grooves 112 are formed along a width extending direction of the connecting member 11. In the first embodiment, the first grooves 111 and the second grooves 112 face the outer diameter 101 of the carrier 10 according to the practical need. In the second embodiment, the first grooves 111 and the second grooves 112 face the inner diameter 102 of the carrier 10 according to the practical need. In both the first and second embodiments, one side of the connecting member 11 having the first grooves 111 and the second grooves 112 or the opposite side of the connecting member 11 having a contact plane 113 can be press-folded to wrap copper wires 201 (as shown in FIGS. 5A and 5B). When the connecting member 11 is press-folded to wrap the copper wires 201, the first grooves 111 and the second grooves 112 are made to be in close contact with the copper wires 201. Then, a pressure is applied to strengthen the bonding between the connecting member 11 and the copper wires 201. For example, a metal material such as tin is filled between the connecting member 11 and the copper wires 201 to increase the contact area between the connecting member 11 and the copper wires 201. As such, the bonding between the connecting member 11 and the copper wires 201 is strengthened and the copper wires 201 are firmly secured. Also, the conductivity is increased. Alternatively, when the connecting member 11 is press-folded to wrap the copper wires 201, the contact plane 113 of the connecting member 11 is made to be in close contact with the copper wires 201 and a pressure is then applied to increase the contact area and the conductivity. For example, a metal material such as tin is filled between the connecting member 11 and the copper wires 201. As such, the bonding between the connecting member 11 and the copper wires 201 is strengthened and the copper wires 201 are firmly secured. Also, the conductivity is increased.

It should be noted that the carrier 10 and the connecting member 11 are integrally formed through a mechanical process such as stamping or molding, thus increasing the processing convenience and product reliability and reducing the fabrication cost.

Referring to FIGS. 2C and 2D, the second grooves 112 intersect with the first grooves 111. The connecting member 11 has a first thickness T1, and the first grooves 111 or the second grooves 112 have a second thickness T2. The second thickness T2 is not greater than two thirds of the first thickness T1. Otherwise, too deep grooves 111, 112 may reduce the strength of the connecting member 11. Therefore, the relationship between the first thickness T1 and the second thickness T2 facilitates to reduce required processing stresses applied for folding the connecting member 11 to wrap the copper wires 201, thereby increasing the processing convenience of the connecting member 11. The first grooves 111 or the second grooves 112 can be with a U shape, a semi-circular shape or a V shape in cross-section thereof. In other embodiments, the first grooves 111 or the second grooves 112 may have such as a polygonal shape in cross section.

FIG. 3 is a schematic view showing folding of the connecting member 11. Therein, the connecting member 11 of the first embodiment is exemplified.

According to the inscribed circle principle, the number of the first grooves 111 and the second grooves 112 are defined and formed. Accordingly, the connecting member 11 is press-folded into a triangular shape, a quadrangular shape and a polygonal shape. In the present disclosure, four second grooves 112 are formed. As such, after being press-folded, the connecting member 11 assumes a ring shape and has a receiving space S for firmly securing the copper wires 201 (as shown in FIGS. 5A and 5B).

It should be noted that FIG. 3 shows the shape of the connecting member 11 after being press-folded to wrap and firmly secure the copper wires 201 through the first grooves 111 and the second grooves 112, and FIGS. 5A and 5B show the shape of the connecting member 11 after being press-folded and bend inward to wrap and firmly secure the copper wires 201 through the contact plane 113.

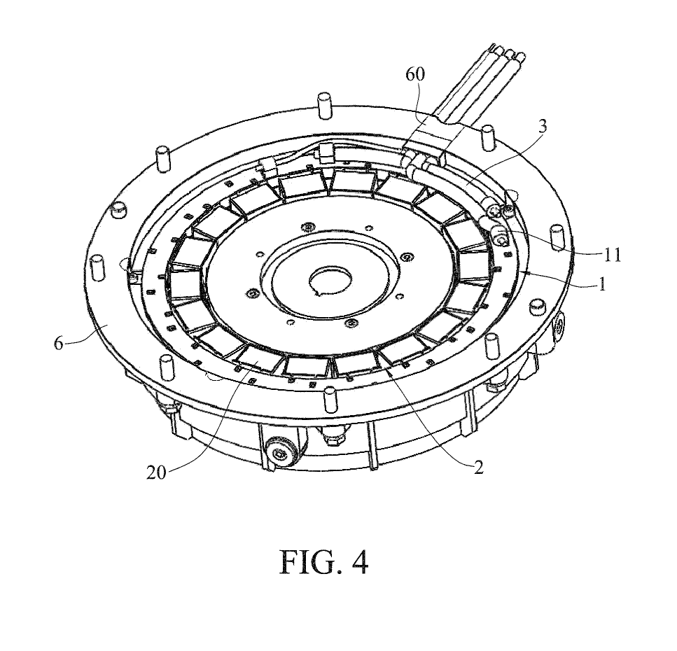

FIG. 4 is a schematic partial view of an ISG of the present disclosure. Referring to FIG. 4, a stator 2, a power collection device 1 disposed around an outer periphery of the stator 2 and a housing 6 for receiving the stator 2 and the power collection device 1 are shown.

The stator 2 has a plurality of winding units 20. The copper wires of the winding units 20 are connected to the connecting member 11 of the power collection device 1 so as to be collected into phase cables 3. The phase cables 3 are further connected to a fixing mechanism 60 of the housing 6. The fixing mechanism 60 has waterproof and dustproof functions. The fixing mechanism 60 fixes the phase cables 3 and strengthens sealing of the housing 6. According to the number of electrical phases of the ISG more than one phase cable 3 is provided. In the embodiment of FIG. 4, three phase cables are provided.

Referring to FIGS. 5A and 5B, the copper wires 201 of the winding units 20 are collected in the receiving space S of the connecting member 11. The connecting member 11 is easily press-folded through the first grooves 111 and the second grooves 112, and an external force is applied on an upper portion of the connecting member 11 to cause an upper middle portion of the receiving space S to bend inward (as shown in FIG. 5B). As such, the contact area between the connecting member 11 and the copper wires 201 is increased and hence the copper wires 201 are firmly secured in the connecting member 11 and the conductivity is increased.

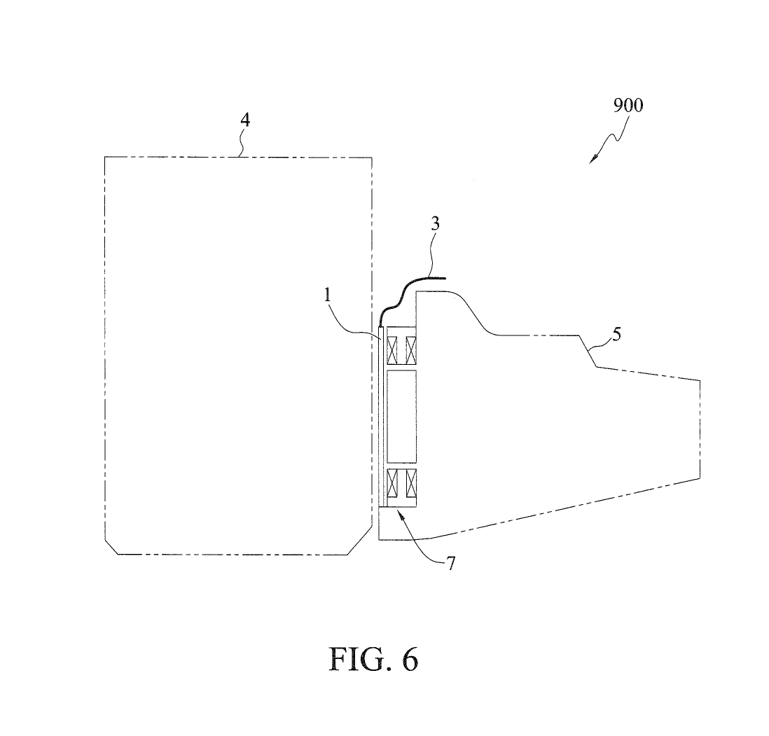

FIG. 6 is a schematic view of a mild hybrid propulsion system 900 of the present disclosure. Referring to FIG. 6, an ISG 7 of the present disclosure is sandwiched between an engine 4 and a transmission 5. Copper wires are collected by the connecting member 11 of the power collection device 1 (shown in FIG. 4) of the ISG 7 into phase cables 3 and directly received in the housing 6 (shown in FIG. 4). As such, the phase cables 3 can be directly pulled out and electrically connected to an external electronic element. Therefore, the present disclosure dispenses with the conventional guiding mechanism, reduces the volume of the ISG 7, and meets the miniaturization requirement of the mild hybrid propulsion system 900.

According to the present disclosure, the carrier and the connecting member are integrally formed through a mechanical process such as stamping or molding, thus increasing the processing convenience and product reliability and reducing the fabrication cost.

Further, the first grooves and the second grooves of the connecting member facilitate to reduce processing stresses applied for folding the connecting member to wrap the copper wires, thereby increasing the processing convenience of the connecting member.

Furthermore, since the copper wires are directly collected by the connecting member into phase cables that are directly received in the housing, the present disclosure dispenses with the conventional guiding mechanism that is disposed outside the housing for collecting the copper wires into phase cables, thereby reducing the volume of the ISG and meeting the miniaturization requirement of the mild hybrid propulsion system. Also, the present disclosure reduces locking mechanisms for terminals.

In the following detailed description, for purposes of explanation, numerous specific details are set forth in order to provide a through understanding of the disclosed embodiments. It will be apparent, however, that one or more embodiments may be practiced without these specific details. In other instances, well-known structures and devices are schematically shown in order to simplify the drawing.

What is claimed is:

1. A power collection device for an electric machine, comprising:
a carrier of a ring shape having a first surface and a second surface; and
at least a connecting member protruding outward from the first surface of the carrier, and having at least a first groove and a plane formed on two opposite sides of the connecting member, respectively.

2. The device of claim 1, wherein the connecting member is formed in a plate shape, and the at least a first groove is formed along a length extending direction of the connection member.

3. The device of claim 2, wherein the connecting member has a first thickness and the first groove has a second thickness not greater than two thirds of the first thickness of the connecting member.

4. The device of claim 1, wherein the connecting member further has at least a second groove formed along a width extending direction of the connecting member and intersecting with the at least a first groove.

5. The device of claim 4, wherein the carrier is in a ring shape, and the first groove and the second groove face an inner diameter or an outer diameter of the carrier.

6. The device of claim 1, wherein the number of the first groove is at least two.

7. The device of claim 4, wherein the number of the second groove is at least three.

8. The device of claim 4, wherein the first groove and the second groove of the connecting member are with a U shape, semi-circular shape or V shape in cross-section thereof.

9. The device of claim 1, wherein the connecting member is press-folded into a triangular shape, a quadrangular shape and a polygonal shape.

10. The device of claim 1, wherein the at least a connecting member that has the first groove and the plane formed on the two sides thereof can be press-folded to wrap copper wires.
